(19) United States
(12) Patent Application Publication
(10) Pub. No.: US 2011/0202620 A1
(43) Pub. Date: Aug. 18, 2011

(54) METHOD AND DEVICE FOR INTERCEPTING JUNK MAIL

(75) Inventor: Hui WANG, Shenzhen City (CN)

(73) Assignee: TENCENT TECHNOLOGY (SHENZHEN) COMPANY LIMITED, Shenzhen (CN)

(21) Appl. No.: 13/097,379

(22) Filed: Apr. 29, 2011

Related U.S. Application Data
(63) Continuation of application No. PCT/CN2009/074991, filed on Nov. 17, 2009.

(30) Foreign Application Priority Data
Dec. 2, 2008 (CN) 200810227762.X

(51) Int. Cl. G06F 15/16

(52) U.S. Cl. 709/206

(57) ABSTRACT

A method and a device for intercepting a junk mail are provided. The method mainly includes: A: obtaining text data of a mail which requires filtering processing; B: determining whether the text data contain a keyword in a string contained in a string database for mail filtering, and if the text data contain the keyword in the string contained in the string database for mail filtering, further determining whether the text data comprise a string corresponding to the keyword contained in the string database; and C: determining whether the mail is a junk mail according to a result of the further determining and according to a predetermined determining policy, and intercepting the mail if the mail is the junk mail. By the method and device, the scanning efficiency and the scanning speed can be improved, and real-time filtering for the mail can be implemented even when the string database has a relatively large dimension.

### FIELD OF THE INVENTION

The present invention relates to the field of network communication technologies, and particularly to a method and device for intercepting a junk mail.

### BACKGROUND OF THE INVENTION

In the email field, junk mails increasingly spread, which not only increases processing time of a normal mail user, but also wastes valuable resources of a mail system, thus obstructing a process of obtaining useful information by a user. Therefore, the junk mail problem should be solved.

At present, an interception technique based on a string is typically adopted to prevent the junk mail in the mail system. In the interception technique based on the string, it is required to establish a string database. The string in the string database employs an existing single word or phrase, and a length of the string is relatively fixed. The string database needs to have a certain update cycle and dimension, and the dimension of scannable strings in the string database often reaches a million scale. In practical applications, by using the string in the string database described above, a received mail is filtered in a processing manner of full-text sequential scanning or regular expression matching so as to determine whether the received mail is a junk mail or a not mal mail, and the received mail is intercepted if it is a junk mail.

In implementing the present invention, the inventor finds that there are at least the following problems in the prior art.

Constructing the string using the existing single word or phrase may lead to a relatively serious false positive rate because such existing single word or phrase is presented not only in the junk mail, but also sometimes in the normal mail, thus leading to false determination.

Since a complete string in the string database is used to filter the mail, the above-described processing manner of full-text sequential scanning or regular expression matching is inefficient when the dimension of the string database is relatively large, and real-time filtering for the received mail cannot be implemented, which significantly affects usage experience of the user.

### SUMMARY OF THE INVENTION

Examples of the present invention provide a method and device for intercepting a junk mail, so as to decrease a false positive rate of the junk mail and to improve a filtering efficiency of the mail.

A method for intercepting junk mail, which includes:

A: obtaining text data of a mail which requires filtering processing;

B: deteimining whether the text data contain a keyword in a string contained in a string database for mail filtering, and if the text data contain the keyword in the string contained in the string database for mail filtering, further determining whether the text data contain a string corresponding to the keyword contained in the string database; and

C: determining whether the mail is a junk mail according to a result of the further determining and according to a predetermined determining policy, and intercepting the mail if the mail is the junk mail.

A device for intercepting junk mail includes:

a text data obtaining module, configured to obtain text data of a mail which requires filtering processing;

a character determining module, configured to determine whether the text data contain a keyword in a string contained in a string database for mail filtering, and if the text data contain the keyword in the string contained in the string database for mail filtering, further determine whether the text data contain a string corresponding to the keyword contained in the string database; and

a mail processing module, configured to determine, according to a result of further determining from the character determining module as well as a predetermined determining policy, whether the mail is the junk mail, and intercept the mail if the mail is the junk mail.

It can be seen from the above technical solutions provided by the examples of the present invention that in the examples of the present invention, the text data of the mail are scanned according to the keyword, the text data of the mail are then scanned according to the string corresponding to the keyword after matching of the keyword, thus a scanning speed and efficiency can be improved, and real-time filtering for the mail can be implemented even when the string database has a relatively large dimension.

### BRIEF DESCRIPTION OF THE DRAWINGS

In order to explain the technical solutions in examples of the present invention more clearly, the accompanying drawings required in describing the examples are concisely listed below. It is apparent that the accompanying drawings in the description below are merely some examples of the present invention, and for those ordinarily skilled in the art, other accompanying drawings can also be obtained according to these accompanying drawings without exercising any inventive step. Wherein,

FIG. 1 is a flowchart illustrating a method for intercepting a junk mail in an example of the present invention; and

FIG. 2 is a structural diagram illustrating specific implementation of a device for intercepting a junk mail in another example of the present invention.

### DETAILED DESCRIPTION OF THE INVENTION

In the examples of the present invention, text data of a mail which requires filtering processing are obtained; it is determined whether the obtained text data of the mail contain a keyword in a string in a string database for mail filtering, and when the text data obtained contain the keyword, it is further determined whether the text data contain the string corresponding to the keyword in the string database. According to a determining result regarding whether the text data contain the string corresponding to the keyword in the string database and according to a predetermined determining policy, it is determined whether the mail is a junk mail, and the mail is intercepted if the mail is the junk mail.

Further, after the mail which requires the filtering processing is received, a title and main body contents of the mail are obtained; after the title and the main body contents are stitched to obtain a piece of text data; and the obtained text data are determined as the text data of the mail which requires the filtering processing.

Preferably, the text data may be stored.

Further, the string contained in the string database is constructed by one or more character units. A character unit includes at least one of an English word, a Chinese single word, a single English letter, a half of the Chinese single word or a full-width/half-width punctuation.

Further, the string database corresponds to a hash chief table and a hash link table, where the keyword in the string contained in the string database and length information of the string corresponding to the keyword are stored in the hash chief table, and complete character construction information of the string corresponding to the keyword is stored in the hash link table.

When a determining operation described above is executed, the detail is: extracting a preset number of characters by starting from a first character unit of the text data, detecting whether the hash chief table contains the keyword that is the same as the preset number of characters, and if yes, obtaining the length information (specifically, a length value) corresponding to the keyword, taking out thc corresponding string from the text data according to the length infolination, detecting whether the hash link table contains the string taken out, and if yes, determining that the text data are hit by scanning for one time, and recording the number of times that the text data are hit by scanning, as well as information of the corresponding keyword and string.

If the hash chief table does not contain the keyword that is the same as the preset number of characters, or if the hash link table does not contain the string taken out, the preset number of characters arc taken out after shifting backward by one character unit from the first character unit of the text data, and the characters taken out are processed in accordance with a processing operation for the preset number of characters taken out from the first character unit of the text data until the last preset number of characters in the text data are detected.

Further, the hash chief table and the hash link table are established through: taking out the preset number of characters by starting from the first character in a first string contained in the string database, taking the characters taken out as a keyword, determining whether the preset number of characters from the first character unit in another string other than the first string in the string database are the same as the keyword, and if the same, recording length information of the another string and the keyword in the hash chief table and recording the complete character construction information of the another string in the hash link table; and then

further determining a second string other than a string recorded in the hash link table in the string database, and processing the second string in accordance with a processing operation for the preset number of characters taken out from the first string, until recording all sections of characters taken out by starting from the respective first character units of all strings in the string database and length information thereof in the hash chief table, and recording respective complete character construction information of all corresponding strings in the hash link table.

Further, the determining whether the mail is a junk mail includes: obtaining the recorded number of times that the text data are hit by scanning, as well as the recorded information about the corresponding keyword and the string is recorded when the text data contain the string corresponding to the keyword in the string database, and is then obtained; and

according to the recorded number of times that the text data are hit by scanning as well as the recorded information about the corresponding keyword and the string, it is determined whether the mail is the junk mail based on the predetermined determining policy, and the mail is intercepted if the mail is the junk mail.

Further, the predetermined determining policy contains: the mail is determined as the junk mail when the number of times that the text data are hit by scanning is larger than a preset numbcr of times; or if information of the string is the length of the string hit by scanning, the predetermined determining policy includes: the mail is determined as the junk mail when the number of times that the text data are hit by scanning is larger than the preset number of times and the length of the string hit by scanning is larger than a preset length.

In order to facilitate understanding the examples of the present invention, a further explanation is made hereinafter by several specific examples in combination with the accompanying drawings, and respective examples are not intended to limit the examples of the present invention.

A hash scheme is a storage structure. In the hash scheme, a corresponding relationship is established between a storage position of data and the keyword of the data, and a set of the keywords is mapped to a location set through the corresponding relationship. Setting of the corresponding relationship is flexible, as long as the size of the location set does not go beyond an allowable range. The hash scheme typically includes a hash chief table and a hash link table. In practical applications, it is required to constitute the hash chief table and the hash link table according to an actual situation.

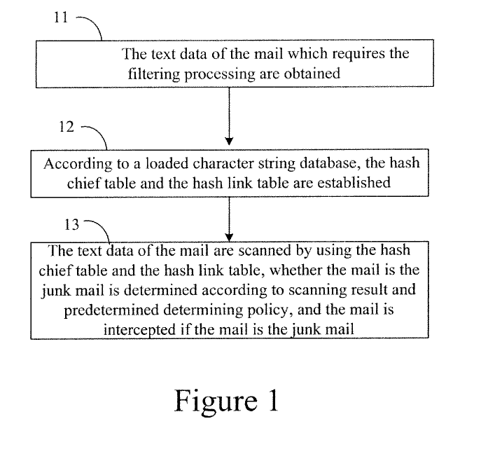

According to an example, a processing procedure of a method for intercepting a junk mail is shown in FIG. 1, and the method includes processing steps as follows:

Step 11: The text data of the mail which requires the filtering processing are obtained.

The detail is: after the mail which requires the filtering processing is received, decoding the mail and obtaining the title and the main body contents of the mail; obtaining a piece of text data through directly stitching the title and the main body contents; and determining the obtained text data as the text data of the mail which requires the filtering processing in Step 11.

Herein, in order to facilitate the interception in the following step, which is specifically shown in Step 13 below, the text data may first be stored temporarily.

Step 12: According to a loaded string database, the hash chief table and the hash link table are established.

Herein, since the hash chief table and the hash link table are established according to the string database, it can be considered that the string database has a corresponding relationship to the hash chief table and the hash link table.

It should be explained that the string contained in the string database is constructed by one or more character units. Specifically, the character unit may be at least one of an English word, a Chinese single word, a single English letter, a half of the Chinese single word or a full-width/half-width punctuation. It can be seen that the string contained in the string database may not be an existing single word or phrase, but a string section having a flexible structure. The string section may be at least one or any combination of the English word, the Chinese single word and the punctuation. Typically, in practical applications, the string mainly exists in a junk mail or a normal mail. Preferably, a situation that the string contained in the string database is presented in the junk mail is taken as an example. It should be noted that this example takes the situation that the string contained in the string database is presented in the junk mail as an example. In consideration of an application scope of the examples of the present invention, the string contained in the string database described above may also exemplarily be the string existing in the normal mail, i.e. the strings in both the normal mail and the junk mail are used simultaneously. Preferably, when both are used simultaneously, specific text data can be scanned and determined by using a method such as any statistical classification algorithm and/or artificial intelligence classification algorithm. For example, the two types of strings in the noimal mail and the junk mail may be trained and tested by using a Bayesian algorithm to obtain a classification model, and the classification model is used to perform subsequent determining of a mail's text contents. Therefore, it can be seen that FIG. 1 merely shows an example, and is not intended to limit application of the examples of the present invention.

In thc example, the hash scheme described above is introduced, and according to the loaded string database, the hash chief table and the hash link table are established. A process for establishing the hash chief table and the hash link table is as follows:

strings in the string database described above are scanned sequentially from the beginning of the string database. Firstly, the first n characters of a first string are taken as a first-level hash index. For description convenience, it is supposed that n is 2. The first-level hash index is then determined as the keyword. For example, the keyword is “SanLu” which represents one Chinese word formed by two Chinese characters. Then, with the keyword as an index, another string other than the first string in the string database described above is searched, and whether the first 2 characters of the another string are the same as the keyword is determined. If the first 2 characters of the another string are the same as the keyword, complete character construction information and length information of the anther string are obtained.

Preferably, in this example, the length information of all of the strings that take the keyword, e.g. “SanLu”, as the first 2 Chinese characters may be stored in the hash chief table. A structure of the hash chief table is as shown in Table 1 listed below. Thereafter, the respective complete character construction information of all of the strings that take the keyword, e.g. “SanLu”, as the first 2 characters is stored in the hash link table. A structure of the hash link table is as shown in Table 2 listed below. Therefore, it can be seen that one keyword corresponds to one hash link table. In the hash scheme, there is only one hash chief table, in which all of keywords and the length information of the strings that take each keyword as the first n characters are stored. There may be multiple hash link tables, which correspond to respective keywords in the hash chief table.

TABLE 1
Hash chief table

| | |
|---|---|
| Keyword | Length value |

| | | | | |
|---|---|---|---|---|
| SanLu | 4 | 5 | 6 | . . . |

. . .

TABLE 2
Hash link table

SanLu milk
SanLu pure milk
SanLu infant milk
. . .

After the above processing such as taking out the keyword for the first string and filling Table 1 and Table 2 according to the keyword, the above processing such as taking out the keyword and filling Table 1 and Table 2 according to the keyword is then performed for another string other than the strings recorded in the hash link table shown in Table 2 in the string database described above, until the length information and the first n characters of all of the strings in the string database are recorded in the hash chief table and the respective complete character construction information of all of the strings is stored in the hash link table.

Thus, through the steps described above, the hash chief table and corresponding hash link tables may be established with respect to the string database.

Step 13: The text data of the mail are scanned by using the hash chief table and the hash link table, whether the mail is the junk mail is determined according to a scanning result and a predetermined determining policy, and the mail is intercepted if the mail is the junk mail.

After the hash chief table and the hash link table described above are established, for the text data of the mail which requires the filtering processing, a string constructed by the first n characters (where n can specifically be 2 or other value) is taken out by starting from the first character of the text data and it is detected whether a keyword which is the same as the string taken out exists in the hash chief table established. If such keyword exists, a first length value corresponding to the string is obtained. Then, the corresponding string is taken out from the text data according to the first length value, and it is detected whether the string taken out exists in the hash link table. If such string exists, it is determined that the scanning hits the text data for one time and information such as the corresponding keyword and the string hit by the scanning is recorded; if such string does not exist, no information will he recorded. The hash chief table is checked again for a next length value corresponding to the string, until all of the length values corresponding to the string are detected.

If the keyword which is the same as the string taken out does not exist in the hash chief table, the hash link table need not be checked. Then, starting from the second character of the text data, the string with 2 characters is taken out. And it is detected whether the hash chief table includes a keyword which is the same as the string taken out by starting from the second character of the text data, and the above detection and determining process with respect to the string taken out by starting from the first character is repeated until the string constructed by the last 2 characters of the text data is detected.

Then, according to the recorded information on the number of times that the scanning hits the text data and the information such as the corresponding keyword and the string hit by the scanning, whether the mail is the junk mail is determined based on the predeteimined determining policy. The predetermined determining policy is designed according to the actual situation, and the determining policy may be as follows: if the number of times that the text data are hit by the scanning is larger than 5, the mail is deteimined as the junk mail, or if the number of times that the text data are hit by the scanning is larger than 4 and the length of the string hit by the scanning is larger than 4, the mail is determined as the junk mail.

The predetermined determining policy should ensure that an entire false positive rate should be smaller than an acceptable false positive rate index, e.g. 0.1%, and an entire interception rate should be larger than an acceptable interception rate index, e.g. 70%.

Then, the determined junk mail is intercepted, and the noiinal mail that is not the junk mail passes.

In the above process for scanning the mail, the text data of the mail are first scanned according to the keyword, and after it is found that the text data of the mail contain the keyword, the text data of the mail are then scanned according to the string corresponding to the keyword. Thus, a scanning speed and efficiency can be improved.

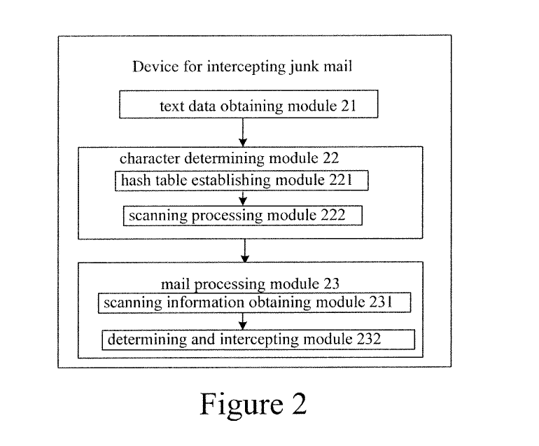

Another example of the present invention also provides a device for intercepting a junk mail. Its specific implementation stnicture is as shown in FIG. 2. The device can specifically include the following:

a text data obtaining module 21, configured to obtain text data of a mail which requires filtering processing;

a character determining module 22, configured to determine whether the text data contain a keyword in a string contained in a string database for mail filtering, and if yes, further determine whether the text data contain the string corresponding to the keyword contained in the string database; and a mail processing module 23, configured to: according to a further determining result from the character determining module 22 and a predetermined determining policy, determine whether the mail is a junk mail, and intercept the mail if it is the junk mail. Herein, the further deteimining result from the character determining module 22 may specifically be a determining result regarding whether the text data contain the string corresponding to the keyword contained in the string database.

The character determining module 22 may specifically include:

a hash table establishing module 221, configured to establish a hash chief table and a hash link table which correspond to the string database, wherein the hash chief table stores the keyword in the string contained in the string database and length information of the string corresponding to the keyword, and the hash link table stores complete character construction information of the string corresponding to the keyword; and

a scanning processing module 222, configured to extract a preset number of characters by starting from a first character unit of the text data, detect whether the hash chief table contains the keyword which is the same as the preset number of characters, and if yes, obtain the length information (specifically, a length value) corresponding to the keyword, take out the corresponding string from the text data according to the length information, detect whether the string taken out exists in the hash link table, and if yes, determine that the text data are hit by the scanning for one time, and record the number of times that the text data are hit by scanning as well as information of the corresponding keyword and string.

If the hash chief table does not contain the keyword which is the same as the preset number of characters, or if the hash link table does not contain the string taken out, the preset number of characters are taken out from the text data after shifting backward by one character unit from the first character of the text data, and the characters taken out after shifting backward by one character unit from the first character of the text data are processed in accordance with a processing operation for the preset number of characters taken out from the first character of the text data, until the last preset number of characters in the text data are detected.

The mail processing module 23 specifically includes:
a scanning information obtaining module 231, configured to obtain the recorded information about the number of times that the text data are hit by scanning, as well as the recorded information about the corresponding keyword and string. Specifically, the information about the number of times that the text data are hit by scanning, as well as the information about the corresponding keyword and string is recorded when the text data contain the string corresponding to the keyword in the string database; and
a determining and intercepting module 232, configured to determine, according to the information about the number of times that the text data are hit by scanning as well as according to the information of the corresponding keyword and string, whether the mail is the junk mail based on the predetermined determining policy; and intercept the mail if the mail is determined as the junk mail.

Those ordinarily skilled in the art can understand that all or part of the procedure in the method in the examples described above may be implemented by a computer program instructing relevant hardware. The program may be stored in a computer readable storage medium. When the program is executed, the procedure in the examples for respective methods described above may be implemented. Specifically, the storage medium maybe a magnetic disc, an optical disc, a Read-Only Memory (ROM) or a Random Access Memory (RAM), etc.

To sum up, by using the string section having the flexible structure that is presented only in the junk mail instead of using a single word or phrase, the examples of the present invention can solve the false determination problem in the prior art, and have a relatively low false positive rate and a relatively high interception rate.

By using the hash chief table and the hash link table in the hash scheme, the examples of the present invention scan the text data of the mail, which can greatly improve the scanning efficiency and improve the scanning speed, and can implement real-time filtering for the mail even when the string database has a relatively large dimension.

The foregoing is merely preferred examples of the present invention, and the scope of the present invention is not limited thereto. Any variations or alternations easily made without departing from the technical scope of the present invention by those skilled in the art should be encompassed within the scope of the present invention. Therefore, the scope of the present invention should be as defined by the appended claims.

What is claimed:

1. A method for intercepting a junk mail, comprising steps of:
A: obtaining text data of a mail which requires filtering processing;
B: determining whether the text data comprise a keyword in a string contained in a string database for mail filtering, and if the text data comprise the keyword in the string contained in the string database for mail filtering, further determining whether the text data comprise a string corresponding to the keyword contained in the string database; and
C: determining whether the mail is a junk mail according to a result of the further determining and according to a predetermined determining policy, and intercepting the mail if the mail is the junk mail.

2. The method according to claim 1, wherein the Step A comprises:
after receiving the mail which requires the filtering processing, obtaining a title and main body contents of the mail; stitching the title and the main body contents to obtain text data; and determining the obtained text data as the text data of the mail which requires the filtering processing.

3. The method according to claim 1, wherein the string contained in the string database is constructed by one or more character units; wherein the character unit comprises at least one of an English word, a Chinese single word, a single English letter, a half of the Chinese single word or a full-width/half-width punctuation.

4. The method according to claim 1, wherein the string database corresponds to a hash chief table and a hash link table;
wherein hash chief table stores the keyword in the string contained in the string database and length information of the string corresponding to the keyword, and the hash link table stores complete character construction information of the string corresponding to the keyword;
wherein the Step B comprises:
B1: extracting a preset number of characters by starting from a first character of the text data, detecting whether the hash chief table contains a keyword that is thc same as thc preset number of characters, and if the hash chief table contains a keyword that is the same as the preset number of characters, obtaining the length information corresponding to the keyword, taking out a string from the text data according to the length information, detecting whether the hash link table contains the string taken out; and i f the hash link table contains the string taken out, determining that the text data are hit by scanning for one time, and recording the number of times that the text data arc hit by scanning as well as information about the keyword and the string corresponding to the keyword; and
B2: if the hash chief table does not contain the keyword that is the same as the preset number of characters, or if the hash link table does not contain the string taken out, taking out the preset number of characters after shifting backward by a character unit from the first character of the text data, and processing the characters taken out in accordance with a processing operation for the preset number of characters taken out from the first character of the text data in Step B1, until detecting a last preset number of characters in the text data.

5. The method according to claim 4, wherein the hash chief table and the hash link table are established through:
B01: taking out the preset number of characters by starting from the first character unit in a first string contained in the string database, taking the characters taken out as the keyword, determining whether the preset number of characters from the first character unit in another string other than the first string in the string database are the same as the keyword, and if the same, recording the keyword and length information of the another string in the hash chief table and recording complete character construction information of the another string in the hash link table; and
B02: further determining a second string other than a string recorded in the hash link table in the string database, and processing the second string in accordance with a processing operation for the first string in Step B01, until finishing the processing operation for the first string in Step B01 for all strings contained in the string database.

6. The method according to claim 4, wherein Step C comprises:
C1: obtaining the recorded number of times that thc text data arc hit by scanning, as well as the recorded infot illation about the keyword and the string corresponding to the keyword; and C2: according to the recorded number of times that the text data are hit by scanning as well as the recorded information about the keyword and the string corresponding to the keyword, determining whether the mail is the junk mail based on the predetermined determining policy, and intercepting the mail if the mail is the junk mail.

7. The method according to claim 6, wherein the predetermined determining policy comprises: the mail is determined as the junk mail when the number of times that the text data are hit by scanning is larger than a preset number of times; or
if information about the string in Step C1 is length of the string hit by scanning, the predetermined determining policy in Step C2 comprises: the mail is determined as the junk mail when the number of times that the text data are hit by scanning is larger than the preset number of times and the length of the string hit by scanning is larger than a preset length.

8. A device for intercepting a junk mail, comprising:
a text data obtaining module, configured to obtain text data of a mail which requires filtering processing;
a character determining module, configured to determine whether the text data comprise a keyword in a string contained in a string database for mail filtering, and if the text data comprise the keyword in the string contained in the string database for mail filtering, further determine whether the text data comprise a string corresponding to the keyword contained in the string database; and
a mail processing module, configured to determine, according to a result of further detelinining from the character determining module as well as a predetermined determining policy, whether the mail is the junk mail, and intercept the mail if the mail is the junk mail.

9. The device according to claim 8, wherein the character determining module comprises:
a hash table establishing module, configured to establish a hash chief table and a hash link table which correspond to the string database, wherein the hash chief table stores the keyword in the string contained in the string database and length information of the string corresponding to the keyword, and the hash link table stores complete character construction information of the string corresponding to the keyword; and
a scanning processing module, configured to extract a preset number of characters by starting from a first character unit of the text data, detect whether the hash chief table contains the keyword that is the samc as the preset number of characters, and if the hash chief table contains a keyword that is the same as the preset number of characters, obtain the length information corresponding to the keyword, take out a string from the text data according to the length information, detect whether the hash link table contains the string taken out, and if the hash link table contains the string taken out, determine that the text data are hit by scanning for one time, and record the number of times that the text data are hit by scanning as well as information about the keyword and the string corresponding to the keyword; and if the hash chief table does not contain the keyword that is the same as the preset number of characters or if the hash link table does not contain the string taken out, configured to take out thc preset number of characters after shifting backward by a character unit from the first character of the text data, and process the characters taken out after shifting backward by a character unit from the first character of the text data in accordance with a processing operation for the preset number of characters taken out by starting from the first character unit of the text data until detecting a last preset number of characters in the text data.

10. The device according to claim 9, wherein the mail processing module comprises:
a scanning information obtaining module, configured to obtain the recorded number of times that the text data are hit by scanning, as well as the recorded information about the keyword and the string corresponding to the keyword; and
a determining and intercepting module, configured to determine, according to the recorded number of time that the text data are hit by scanning as well as according to the recorded information about the keyword and the string corresponding to the keyword, whether the mail is the junk mail based on the predetetmined determining policy, and intercept the mail if the mail is the junk mail.
